(19) United States
(12) Patent Application Publication
(10) Pub. No.: US 2009/0070579 A1
(43) Pub. Date: Mar. 12, 2009

(54) Information processing system and login method

(75) Inventors: Toshihiko Murakami, Fujisawa (JP); Daiki Nakatsuka, Yokohama (JP)

Correspondence Address: Stanley P. Fisher;Reed Smith LLP, 3110 Fairview Park Drive, Suite 1400, Falls Church, VA, 22042-4503, US

(73) Assignee: Hitachi, Ltd.

(21) Appl. No.: 12/010,496

(22) Filed: Jan. 25, 2008

(30) Foreign Application Priority Data
Sep. 6, 2007 (JP) 2007-231646

(51) Int. Cl. H04L 9/00

(52) U.S. Cl. 713/155

(57) ABSTRACT

Provided is an information processing system and a login method capable of simplifying login processing and also simplifying the entire configuration of the system.

Targets are classified into groups, and an address is assigned to each group. An initiator stores the address of each group, and each target stores at least the address assigned to the group the relevant target itself belongs to and information for identifying the initiator that is permitted to connect to itself. When the initiator logs in to a target belonging to a desired group, the initiator issues a login request whose destination is the address assigned to the desired group. When the target receives the login request whose destination is the address assigned to the group to which the relevant target itself belongs to and only when the initiator is permitted to connect to itself, the target transmits a login response to the initiator.

### CROSS-REFERENCES TO RELATED APPLICATIONS

This application relates to and claims priority from Japanese Patent Application No. 2007-231646, filed on Sep. 6, 2007, the entire disclosure of which is incorporated herein by reference.

### BACKGROUND

1. Field of the Invention

The invention relates generally to an information processing system and a login method and is suitable for use in, for example, a storage system.

2. Description of Related Art

In the iSCSI (internet SCSI (Small computer System Interface) standard, an initiator needs to log in to a target before a phase of exchanging data or commands between the initiator and the target. In a storage system having a host computer and a storage apparatus connected to each other via a network, login processing is typically performed with the host computer serving as an initiator and the storage apparatus serving as a target, where the host computer logs in to the storage apparatus. However, the storage apparatus sometimes serves as an initiator, like in an arrangement where data is copied between storage apparatuses.

In such login processing, the initiator needs to recognize in advance the IP address of the target in order to log in to the target. More specifically, the initiator needs to recognize both the IP address and the TCP port number of the target in order to use TCP/IP (Transmission Control Protocol/Internet Protocol) in iSCSI communication.

Reference 1 introduces, in chapter 3, three methods for an initiator to acquire the IP address and the iSCSI name of a target before login—“Static Configuration,” “Send Targets” and “Zero Configuration” (see Reference 1 (non-patent document): M. Bakke, et al., Internet Small Computer Systems Interface (iSCSI) Naming and Discovery, IETF RFC3721, April 2004).

Of the above three discovery methods, in the “Static configuration” and “Send Targets” methods, the initiator needs to recognize in advance the IP address of the target.

On the other hand, the “Zero Configuration” method is a method used when the initiator has no information about the target, where two methods have been introduced: a method using a protocol named SLP (Service Location Protocol) (see Reference 2 (non-patent document): M. Bakke, et al., “Finding Internet Small Computer Systems Interface (iSCSI) Targets and Name Servers by Using Service Location Protocol version 2 (SLPv2), IETF RFC4018, April 2005); and a method using an iSNS (Internet Storage Name Service) server (see Reference 3 (non-patent document): J. Tseng, et al., Internet Storage Name Service (iSNS), IETF RFC4171, September 2005).

In the method using the SLP disclosed in Reference 2, it is necessary to install a program UA (User Agent) for the SLP in an initiator and to install a program SA (Service Agent) for the SLP in targets. The initiator needs to exchange a service request message and a service response message with the targets before login processing compliant with the iSCSI standard, in order to recognize an available target.

In the method using the iSNS server disclosed in Reference 3, an initiator and a target need to recognize in advance the address of the iSNS server, and in addition, the initiator and the target each need to register in advance their own IP address, TCP port number, iSCSI name and type (initiator or target) in the iSNS server.

As described above, since the SLP program or the iSNS has to be provided in the conventional techniques disclosed in References 2 and 3 in addition to the program required in the login processing that meets the iSCSI standard, extra cost is required to construct and manage the system.

In addition, before the login, the initiator and the target need to exchange messages or the initiator needs to perform inquiry processing to acquire the IP address of the target from the iSCSN server, and therefore the login processing became complicated and it took long time to perform the login processing.

### SUMMARY

In the light of the above problems, it is an object of this invention to propose an information processing system and a login method that are capable of simplifying login processing for an initiator to log in to a target and simplifying the structure of the entire system.

In order to achieve the above object, provided according to an aspect of this invention is an information processing system that includes an initiator and a target(s) and requires login when the initiator accesses the target(s), in which: one or a plurality of targets is classified in one or a plurality of groups, each group being assigned a unique address; the initiator includes an initiator-side login processor that stores the address assigned to each group of the target(s) and, when logging in to a target belonging to a desired group, issues a login request with its destination set to the address assigned to the desired group; and the target(s) includes a target-side login processor that stores at least the address assigned to a group to which the relevant target itself belongs and information for identifying the initiator that is permitted to connect to the relevant target itself, and transmits, when receiving the login request whose destination is the address assigned to the group to which the relevant target itself belongs and only when a transmitter of the login request is an initiator that is permitted to connect to the relevant target itself, a login response to the relevant initiator.

As a result, the information processing system enables the initiator to log in to the target without requiring extra protocols or servers.

Provided according to another aspect of this invention is a login method used for an information processing system that includes an initiator and a target(s) and requires login when the initiator accesses the target(s), the method comprising the steps of: a first step in which one or a plurality of targets is classified into one or a plurality of groups, a unique address is assigned to each group, the initiator stores the address assigned to each target group, and the target(s) stores at least the address assigned to a group to which the relevant target itself belongs and information for identifying an initiator that is permitted to connect to the relevant target itself; a second step in which, the initiator issues, when logging in to a target belonging to a desired group, a login request whose destination is the address assigned to the desired group; and a third step in which the target(s) transmits, when the target(s) receives the login request whose destination is the address assigned to the group to which the relevant target itself belongs and only when a transmitter of the login request is an initiator that is permitted to connect to the relevant target itself, a login response to the relevant initiator.

As a result, the login method enables the initiator to log in to the target without requiring extra protocols or servers.

According to this invention, the login processing for the initiator to log in to the target can be simplified, and in addition, the structure of the entire system can be simplified.

Other aspects and advantages of the invention will be apparent from the following description and the appended claims.

### BRIEF DESCRIPTION OF THE DRAWINGS

FIG. 1 is a block diagram showing an example of the logical configuration of a storage system according to first and second embodiments.

FIG. 2 is a block diagram showing an example of the concrete configuration of the storage system according to the above first and second embodiments.

FIGS. 3A and 3B are block diagrams showing the configuration of programs stored in a host computer and first to third storage apparatuses.

FIG. 4 is a ladder chart explaining a processing sequence for iSCSI login processing using an SLP.

FIG. 5 is a ladder chart explaining a processing sequence for iSCSI login processing according to the above first and second embodiment.

FIGS. 6A to 6C are conceptual diagrams each explaining a LUN mapping table.

FIGS. 7A and 7B are conceptual diagrams each explaining a storage management table.

FIG. 8 is a flowchart showing a processing sequence for iSCSI login processing according to the above first embodiment.

FIG. 9 flowchart showing a processing sequence for IP packet reception processing according to the above first and second embodiment.

FIG. 10 is a schematic diagram schematically showing a LUN mapping table creation/management screen.

FIG. 11 is a schematic diagram schematically showing a storage group management table creation/management screen.

FIG. 12 is a flowchart explaining a processing sequence for iSCSI login processing according to the above second embodiment.

FIG. 13 is a conceptual diagram explaining a processing sequence for the iSCSI login processing according to the above second embodiment.

FIG. 14 is a schematic diagram explaining a LUN mapping table creation/management screen according to another embodiment.

### DETAILED DESCRIPTION OF PREFERRED EMBODIMENTS

A first embodiment of this invention will be described below in detail with reference to the attached drawings.

### (1) First Embodiment

(1-1) Configuration of Storage System in First Embodiment

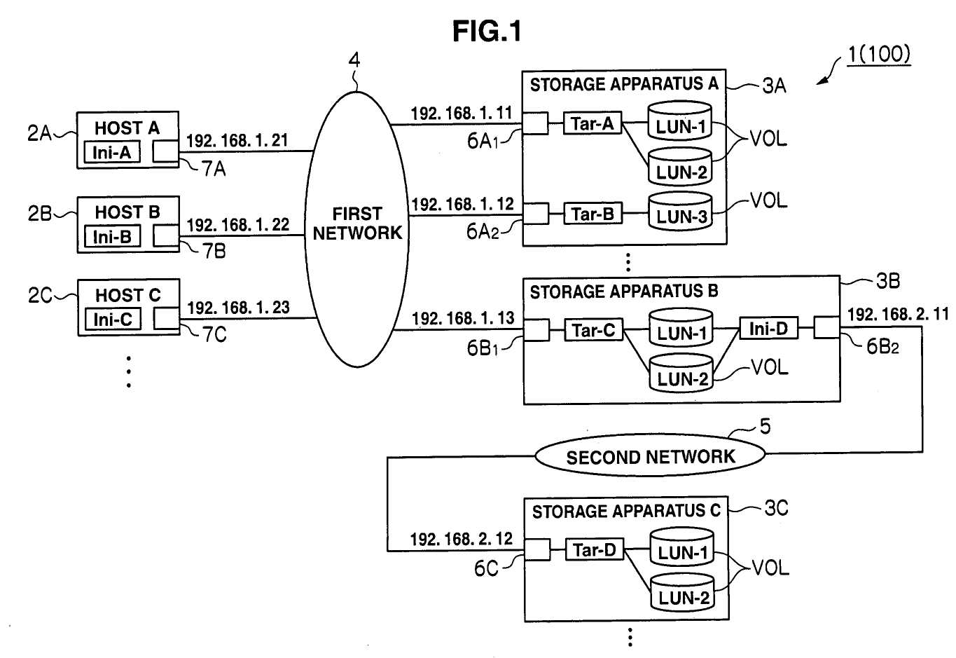

FIG. 1 shows the logical configuration of a storage system 1 according to this embodiment. The storage system 1 includes a plurality of host computers 2A, 2B, 2C . . . and a plurality of storage apparatuses 3A, 3B, 3C . . . . It should be noted that the below description only describes first to third storage apparatuses 3A, 3B and 3C out of the plurality of storage apparatuses 3A, 3B, 3C . . . for ease of explanation.

The first and second storage apparatuses 3A and 3B are connected to host computers 2A, 2B, 2C . . . via a first network 4, which may be a SAN (Storage Area Network) or similar. The second storage apparatus 3B is also connected to the third storage apparatus 3C via a second network 5, which may be an on-site network or inter-site network.

The first to third storage apparatuses 3A to 3C are each provided with one or more ports 6A₁, 6A₂, 6B₁, 6B₂ and 6C used for connection with the first network 4 or the second network 5. A unique IP address (“192.168.1.11,” “192.168.1.12,” “192.168.1.13,” “192.168.2.11” or “192.168.2.12,”) is assigned to each of the ports 6A₁, 6A₂, 6B₁, 6B₂, 6C. Similarly, the host computers 2A, 2B, 2C . . . are respectively provided with ports 7A to 7C used for connection with the first network 4, and a unique IP address (“192.168.1.21,” “192.168.1.22” or “192.168.1.23”) is assigned to each of the ports 7A to 7C.

The host computers 2A, 2B, 2C . . . each have an initiator function that operates as an initiator in iSCSI communication. A unique initiator name is assigned to each initiator function in the host computers 2A, 2B, 2C . . . . The first and third storage apparatuses 3A to 3C each have one or more target functions that operate as a target(s) in iSCSI communication. A unique target name is assigned to each target function in the first to third storage apparatuses 3A to 3C. The second storage apparatus 3B also has an initiator function in addition to the target function, and a unique initiator name is assigned to this initiator function. The target function with the assigned target name is assigned a logical volume VOL that serves as a storage area to be provided for an initiator.

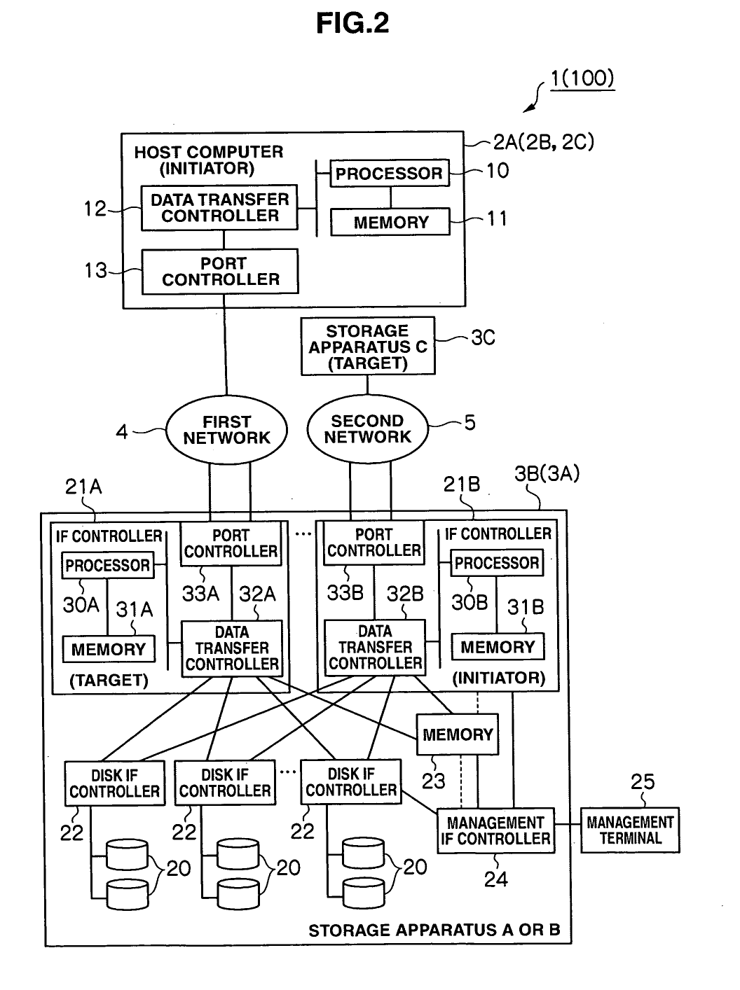

FIG. 2 shows an example of the concrete configuration of the host computers 2A, 2B, 2C . . . and the first to third storage apparatuses 3A to 3C in the above storage system 1.

The host computers (host apparatuses) 2A, 2B, 2C . . . each employ a main frame computer that includes information processing resources such as a processor 10, a memory 11, a data transfer controller 12 and a port controller 13. The processor 10 controls the entire operation of the relevant host computer 2A, 2B, 2C . . . . When the processor 10 executes various control programs stored in the memory 11, the relevant host computer 2A, 2B, 2C . . . as a whole performs the processing described below. The data transfer controller 12 controls data transfer between the memory 11 and the port controller 13. The port controller 13 controls communication between the relevant host computer 2A, 2B, 2C . . . and external devices via the relevant port 7A, 7B or 7C (FIG. 1).

The storage apparatuses 3A to 3C each include a plurality of disk devices 20, a plurality of interface controllers 21A and 21B, a plurality of disk interface controllers 22, a memory 23, a management interface controller 24 and a management terminal 25.

The disk device 20 may be an expensive disk drive such as a SCSI (Small Computer System Interface) disk or an inexpensive disk such as a SATA (Serial AT Attachment) disk and an optical disc. One or more logical volumes VOL (FIG. 1) are defined in a storage area provided by one or more disk devices 20. Data from the host computers 2A, 2B, 2C . . . is stored in this logical volume VOL.

The interface controllers 21A and 21B respectively include processors 30A and 30B, memories 31A and 31B, data transfer controllers 32A and 32B and port controllers 33A and 33B. When the processors 30A and 30B execute various programs stored respectively in the memories 31A and 31B, the interface controllers 21A and 21B as a whole perform various processing. The data transfer controllers 32A and 32B control data transfer between the disk interface controllers 22 and external devices. The port controllers 33A and 33B control communication between the storage apparatuses 3A to 3C and external devices via the ports 6A₁, 6A₂, 6B₁, 6B₂ and 6C (FIG. 1).

The disk interface controller 22 includes a processor, a memory, a data transfer controller and a port controller (each not shown) like the interface controller 21A and 21B, and controls data read or data write in relation to the disk device 20. The memory 23 includes: a cache memory area serving as a primary storage area for data transmitted to/received from the host computers 2A, 2B, 2C . . . ; and a common memory area for storing control information and configuration information in its own storage apparatus.

The management interface controller 24 is configured in a manner similar to the interface controllers 21A and 21B, the management interface controller 24 serving as an interface between its own storage apparatus and a management terminal 25. The management terminal 25 is a computer operated for maintenance or management of its own storage apparatus (the first, second or third storage apparatus 3A, 3B or 3C), which may be a laptop personal computer or the like. The management terminal 25 collects necessary information from its own storage apparatus and displays the collected information on a display screen (not shown), and configures various settings to its own storage apparatus in accordance with an administrator's manipulations.

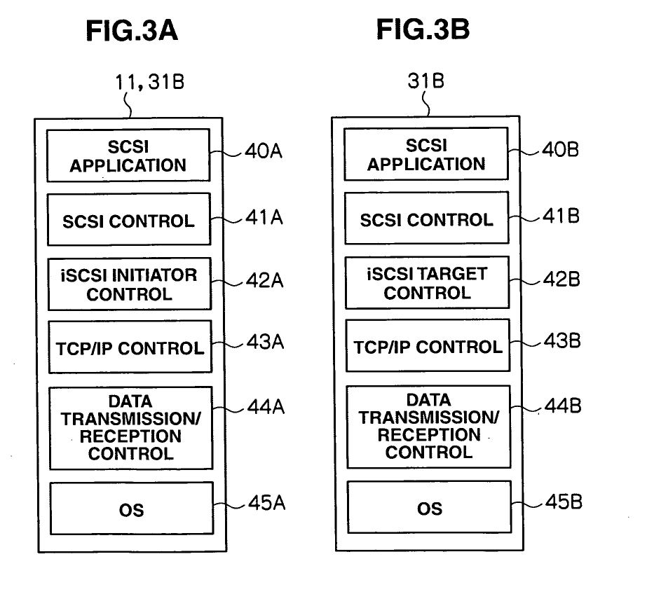

FIGS. 3A and 3B show one example of programs stored in the memories 11 in the host computers 2A, 2B, 2C . . . and memories 31A and 31B in the interface controllers 21A and 21B in each of the first to third storage apparatuses 3A to 3C.

FIG. 3A shows an example of programs stored in the memory 11 in each host computer 2A, 2B, 2C . . . and in the memory 31B in the interface controller 21B connected to the third storage apparatus 3C out of the interface controllers 21A and 21B in the second storage apparatus 3B.

As shown in FIG. 3A, the memories 11 and 31B each store: a SCSI application 40A, which is an application program that meets the SCSI standard; a SCSI control program 41A for performing communication control in compliance with the iSCSI standard; an iSCSI initiator control program 42A that controls the relevant host computer or storage apparatus 3B to serve as an initiator in the iSCSI control; a TCP/IP control program 43A for performing communication control in compliance with the TCP/IP standard; a data transmission/reception control program 44A for controlling data transmission/reception; and an OS (Operating System) 45A.

With this arrangement, the host computers 2A, 2B, 2C . . . each serve as an initiator with relation to the first and second storage apparatuses 3A and 3B based on the iSCSI initiator control program 42A, while the interface controller 21 connected to the third storage apparatus 3C out of the interface controllers 21A and 21B in the second storage apparatus 3B serves as an initiator in relation to the third storage apparatus 3C based on the iSCSI initiator control program 42A.

FIG. 3B shows an example of programs stored in the memory 31A in the interface controller 21A in each of the first and third storage apparatuses 3A and 3C and in the memory 31A in the interface controller 21A connected to the host computers 2A, 2B, 2C . . . out of the interface controllers 21A and 21B in the second storage apparatus 2B.

As shown in FIG. 3B, these memories 31B each store the same programs as those stored in the memory 11 in the host computers 2A, 2B, 2C . . . except that an iSCSI target control program 42B that controls the relevant storage apparatus to serve as a target in the iSCSI communication is stored instead of the iSCSI initiator control program 42A.

With such an arrangement, the interface controller 21A in the first storage apparatus 3A and the interface controller 21A connected to the host computers 2A, 2B, 2C . . . out of the interface controllers 21A and 21B in the second storage apparatus 3B are adapted to serve as targets in relation to the host computers 2A, 2B 2C . . . based on the above-described iSCSI target control program 42B, while the interface controller 21A in the third storage apparatus 3C is adapted to serve as a target in relation to the second storage apparatus 3B based on the above-described iSCSI target control program 42B.

(1-2) Login Method in First Embodiment

(1-2-1) Configuration of Tables

Next, an iSCSI login method from an initiator to a target according to this embodiment will be described. Before describing that, a conventional iSCSI login method in the storage system 1 shown in FIG. 1 will be described.

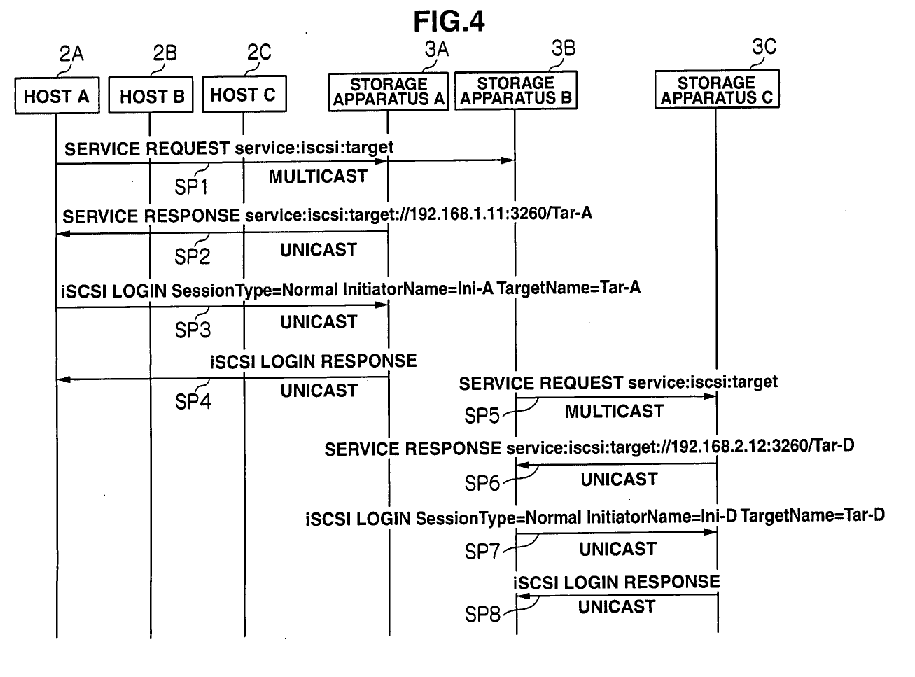

FIG. 4 shows a processing sequence when the host computer 2A logs in to the first or second storage apparatus 3A or 3B via the iSCSI using the SLP. In the example shown in FIG. 4, first, the initiator function of the host computer 2A transmits by multicast a service request message to the first and second storage apparatuses 3A and 3B, where the destination of the service request message is a multicast address that can be received by the first and second storage apparatuses 3A and 3B (SP1). The content of this service request message is to request the target to provide a service.

If the target function of the first storage apparatus 3A can provide the requested service to the host computer 2A, the target function of this first storage apparatus 3A transmits to the host computer 2A a service response message with its destination set to the IP address of the host computer 2A (SP2). This service message contains the IP address and the TCP port number of each port 6A₁ and 6A₂ (FIG. 1) used by the target function of the first storage apparatus 3A and the target name assigned to the relevant target function.

The initiator function of the host computer 2A receiving this service response message acquires the IP address of the target function of the first storage apparatus 3A from the service response message, and transmits to the first storage apparatus 3A an iSCSI login request message with its destination set to the acquired IP address (SP3). Then the target function of the first storage apparatus 3A receiving this iSCSI login request message transmits an iSCSI login response message to the host computer 2A (SP4). Accordingly, the host computer 2A receiving this iSCSI login response message starts login processing for logging in to the first storage apparatus 3A.

When the initiator function of the second storage apparatus 3B logs in to the target function of the third storage apparatus 3C, the same processing sequence as the above is performed (SP5 to SP8) and the login processing is started.

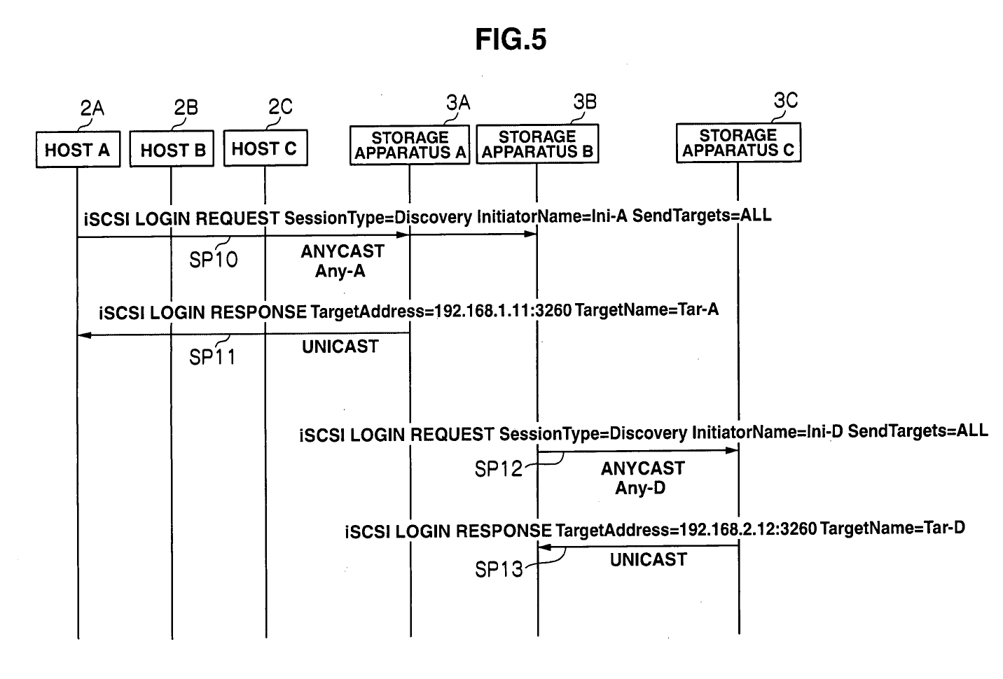

FIG. 5 shows a processing sequence for iSCSI login processing according to this embodiment. In this embodiment, the storage apparatuses are managed by grouping them by application, such as “mail,” “database,” “web,” “backup” and “default” (hereinafter referred to as “storage groups”), and a unique address is assigned to each of these storage groups (hereinafter referred to as an “anycast address”).

In the storage system 1, when an initiator logs in to a target, the initiator issues a login request message with its destination set to an anycast address assigned to a desired service (SP10 and SP12), only targets accessible by the relevant initiator and that have received the login request message transmit a login response message to the initiator (SP11 and SP13), and the initiator receiving this login response message starts the iSCSI login processing for logging in to the relevant target.

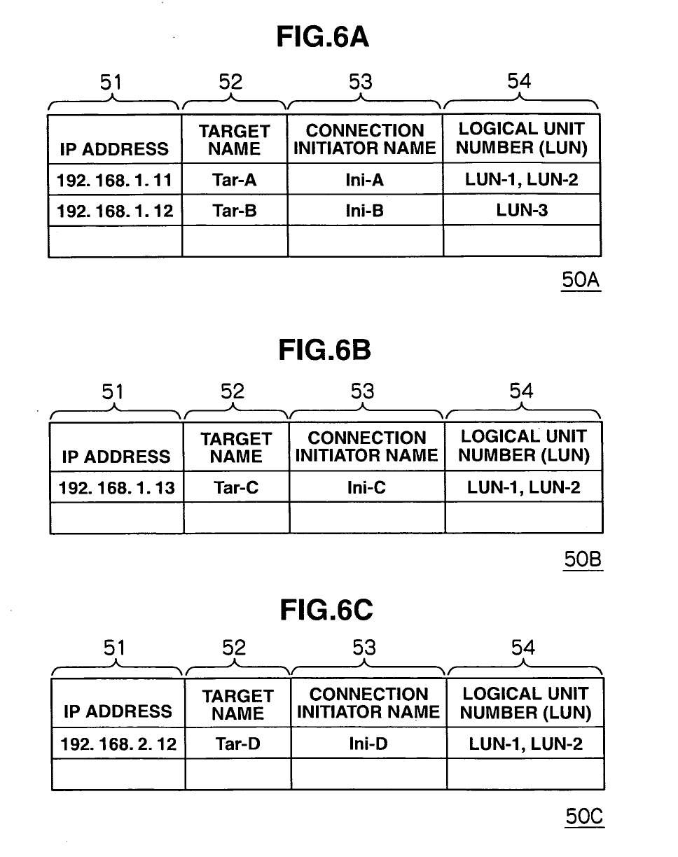

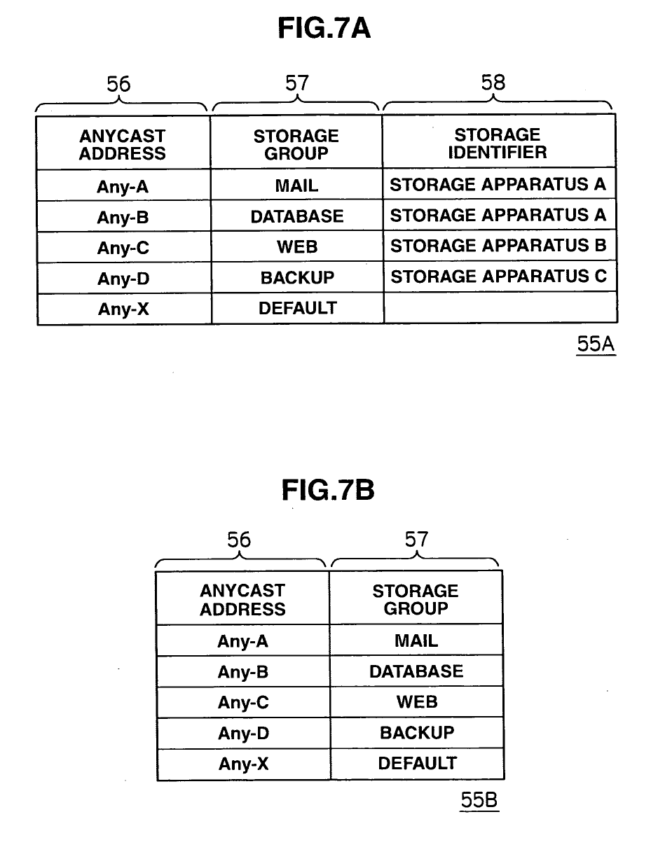

As means for realizing a login method according to this embodiment, the memories 23 in the first to third storage apparatuses 3A to 3C functioning as the targets in iSCSI communication respectively store LUN mapping tables 50A to 50C shown in FIGS. 6A to 6C, while the memories 11 in the host computers 2A, 2B, 2C . . . and the memory 23 in the second storage apparatus 3B functioning as the initiators in the iSCSI communication each store a storage group management table shown in FIG. 7B.

The LUN mapping tables 50A to 50C are tables for managing logical volumes VOL (FIG. 1) that are storage areas provided by the target function of the first to third storage apparatuses 3A to 3C for the initiator functions of the host computers 2A, 2B, 2C . . . or for the initiator function of the second storage apparatus 3B, where FIG. 6A shows a LUN mapping table 50A stored in the first storage apparatus 3A, FIG. 6B shows a LUN mapping table 50B stored in a second storage apparatus 3B and FIG. 6C shows a LUN mapping table 50C stored in the third storage apparatus 3C.

These LUN mapping tables 50A to 50C each include an “IP Address” field 51, a “Target Name” field 52, a “Connection Initiator Name” field 53 and a “Logical Unit Number (LUN)” field 54. The “IP Address” field 51 stores the IP address assigned to the port 6A₁, 6A₂, 6B₁ or 6C (FIG. 1) used by the target function of its own storage apparatus. The “Target Name” field 52 stores the name (target name) assigned to the relevant target function. The “Connection Initiator Name” field 53 stores the name (initiator name) of the initiator that is permitted to connect to the relevant target function. The “Logical Unit Number (LUN)” field 54 stores the LUN of the logical volume VOL accessible by the relevant initiator.

Accordingly, FIG. 6A indicates that the target function using the port 6A₁ (FIG. 1) that has been assigned the IP address “192.168.1.11” is assigned the target name “Tar-A,” this target function is accessible by the initiator named “Ini-A,” and this initiator has been provided with the logical volumes of “LUN-1” and “LUN-2.”

Storage group management tables 55A and 55B are tables used by the initiator functions of the second storage apparatus 3B and the host computers 2A, 2B, 2C . . . , and the target functions of the first to third storage apparatuses 3A to 3C to manage the storage groups and the anycast addresses. FIG. 7A shows a storage group management table 55A stored in the first to third storage apparatuses 3A to 3C (hereinafter referred to as a first storage group management table), and FIG. 7B shows a storage management table 55B stored in the host computers 2A, 2B, 2C . . . and the second storage apparatus 3B (hereinafter referred to as a second storage management table).

The first storage group management table 55A includes an “Anycast Address field” 56, a “Storage Group” field 57 and a “Storage Identifier” field 58. The “Anycast Address” field 56 stores the anycast address assigned to the corresponding storage group, and the “Storage Group” field 57 stores the name of the relevant storage group. The “Storage Identifier” field 58 stores the identifier of the storage apparatus (the first, second or third storage apparatus 3A, 3B or 3C) that belongs to the relevant storage group.

The second storage group management table 55B includes an “Anycast Address” field 56 and a “Storage Group” field 57. The “Anycast Address” field 56 and the “Storage Group” field 57 store the same information respectively as the “Anycast Address” field 56 and the “Storage Group” field 57 in the first storage group management table 55A.

Accordingly, the example in FIGS. 7A and 7B indicates that the anycast address “Any-A” is assigned to a storage group providing the service “mail,” and the storage apparatus that has been assigned the storage identifier “storage A” (the first storage apparatus 3A) belongs to that group.

The “default” storage group is a storage group to which a storage apparatus (the first, second or third storage apparatus 3A, 3B or 3C) that has not belonged to any storage group defined in advance, and an anycast address “Any-X” is assigned to that “default” storage group in this embodiment.

(1-2-2) Processing Sequence for Login Processing in First Embodiment

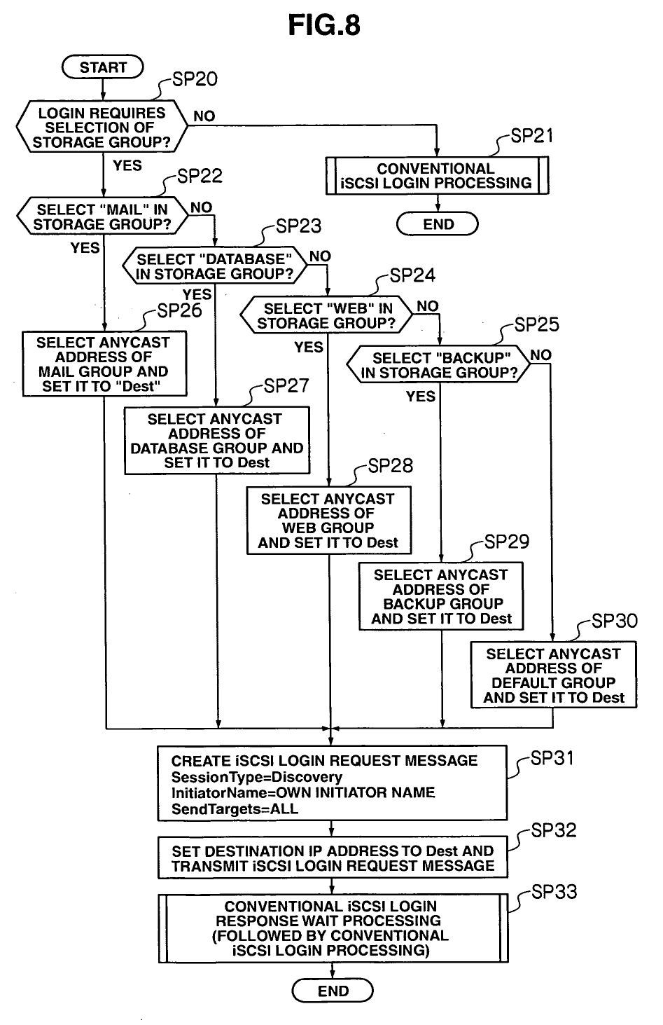

FIG. 8 is a flowchart showing the processing sequence for the login processing according to this embodiment, and more specifically, the processing sequence for the iSCSI login processing performed by processors in the initiators, i.e., the processor 10 in the host computer 101 (FIG. 2), or the processor 30B in the interface controller 21B that serves as the initiator in the second storage apparatus 3B (FIG. 2). The processors 10 and 30B perform the iSCSI login processing shown in FIG. 8 based on the iSCSI initiator control programs 42A (FIG. 4) stored in the respective memories 11 and 31B (FIG. 2).

Specifically, when an execution command for the login processing is input by a user operation, the processor 10 or 30B starts the iSCSI login processing. First, the processor 10 or 30B judges whether or not the execution command for the login processing is a login processing execution command commanding the selection of a storage group (SP20).

If the input login processing execution command is a normal one and does not command the selection of a storage group, the processor 10 or 30B performs conventional iSCSI login processing using, for example, a SLP (SP21), and then terminates the iSCSI login processing.

On the other hand, if the input login processing execution command is one commanding selection of a storage group, the processor 10 or 30B judges which storage group the user has specified by sequentially checking storage groups of “mail,” “database,” “web” and “backup” (SP22 to 25).

If the specified storage group is “mail,” the processor 10 or 30B reads the anycast address (“Any-A” in FIGS. 7A and 7B) of the relevant storage group from the storage group management tables 55B add 55A (FIGS. 7A and 7B), and sets the read anycast address to a variable “Dest” (SP26).

If the specified storage group is “database,” “web” or “backup,” the processor 10 or 30B reads the anycast address (“Any-B,” “Any-C” or “Any-D” in FIG. 7A or 7B) of the relevant storage group from the relevant storage group management table 55B or 55A, and sets the read anycast address to a variable “Dest” (SP27 to SP29).

If the specified storage group is none of “mail,” “database,” “web” and “backup,” or if the storage group is not specified, the processor 10 or 30B reads the anycast address (“Any-X” in FIG. 7A or 7B) of the “default” storage group from the relevant storage group management table 55B or 55A, and sets the read anycast address to a variable “Dest” (SP30).

Next, the processor 10 or 30B creates an iSCSI login request message by setting the “Session Type” to “Discovery,” setting “Initiator Name” to the initiator name of the relevant initiator function and setting a destination target (“Send Target”) to all targets “ALL” (SP31).

Then the processor 10 or 30B creates an IP packet by assigning the anycast address that has been set to the variable “Dest” in steps SP26 to SP 30 to the destination IP address in this iSCSI login request message, and outputs this IP packet to the relevant first network 4 or second network 5 (SP32).

After that, the processor 10 or 30B waits for an iSCSI login response message in response to the above iSCSI login request message. Upon the reception of this iSCSI login response message, the processor 10 or 30B performs the conventional login processing (SP33). This iSCSI login processing may be performed as follows: timer monitoring is performed, and if one iSCSI login response message is received within in a certain time period, the processor 10 or 30B logs in to the target that has transmitted the one iSCSI login response message, while if a plurality of iSCSI login response messages has been received in the certain time period, the processor 10 or 30B selects all of or some of the targets that have transmitted the iSCSI login response messages and logs in to the selected target(s).

When the above login processing is complete, the processor 10 or 30B terminates the iSCSI login processing.

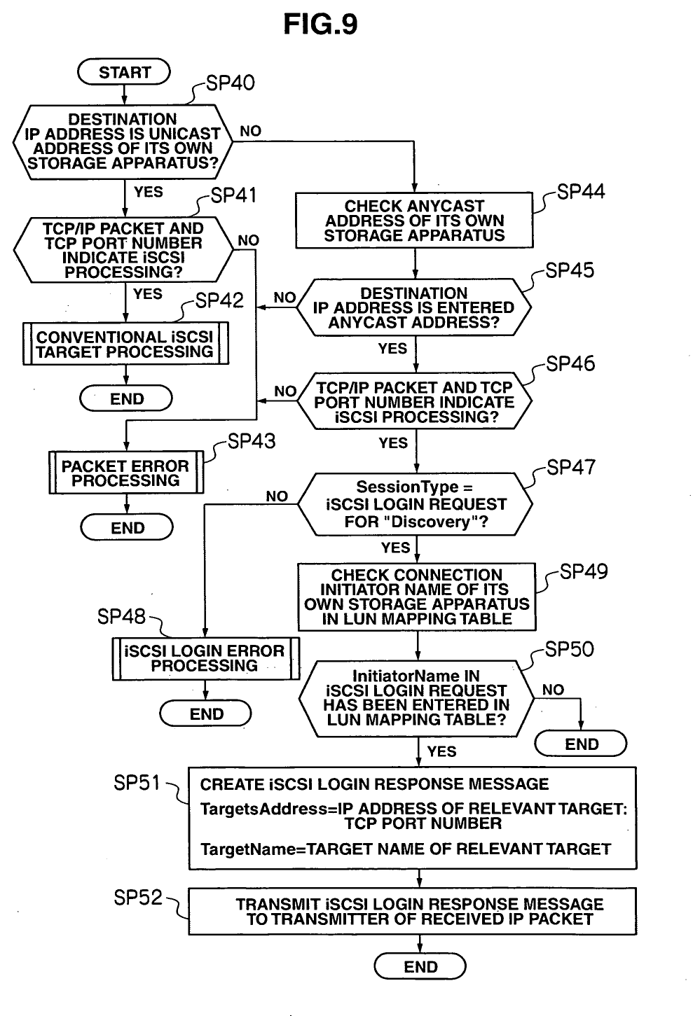

FIG. 9 is a flowchart showing a processing sequence for IP packet reception processing performed by a processor in a target that has received an IP packet from an initiator, i.e., the processor 30A (FIG. 2) in the interface controller 21A serving as the target in the first, second or third storage apparatus 3A, 3B or 3C. The processor 30A performs the IP packet reception processing shown in FIG. 9 based on the iSCSI target control program 42B (FIG. 4) stored in the relevant memory 31A (FIG. 2).

Specifically, when receiving an IP packet from an initiator, the processor 30A in the target starts this IP packet reception processing. First, the processor 30A judges whether or not the destination IP address in the iSCSI login request message is the IP address assigned to any of the ports 6A₁, 6A₂, 6B₁ and 6C in its own storage apparatus (SP40).

If the result of this judgment is positive, the processor 30A then judges whether or not the IP packet in the iSCSI login request message is the TCP/IP packet and the TCP port number is the number indicating the iSCSI processing (SP41).

If the result of this judgment is positive, the processor 30A performs conventional target processing such as iSCSI login processing and read/write processing (SP42), and terminates the IP packet reception processing.

On the other hand, if the result of the judgment in SP41 is negative, the processor 30A cannot perform the processing according to the message stored in the relevant IP packet and so performs packet error processing such as cancellation of the IP packet and log recording (SP43), and terminates this IP packet reception processing.

On the other hand, if the result of the judgment in step S40 is negative, the processor 30A refers to the storage group management table 55A to check the anycast address of the storage group to which its own storage apparatus belongs (SP44), and judges whether or not the destination IP address of the relevant IP packet is the anycast address of the storage group that its own storage apparatus belongs to (SP45).

If the result of this judgment is negative, the processor 30A proceeds to step SP43, while if the result is positive, the processor 30A judges whether or not the IP packet in the iSCSI login request is a TCP/IP packet and the TCP port number indicates the iSCSI processing (SP46).

If the result of this judgment is negative, the processor 30A proceeds to step SP43, while if the result is positive, the processor 30A judges whether or not the content “Session type” of the relevant IP packet is “Discovery” in the iSCSI login request message (SP47).

If the result of this judgment is negative, the processor 30A performs predetermined iSCSI login error processing (SP48). On the other hand, if the result of this judgment is positive, the processor 30A refers to the relevant LUN mapping table 50A, 50B or 50C to check the connection initiator name of its own storage apparatus (SP49), and judges whether or not the “initiator name” in the iSCSI login request message has been entered in the relevant LUN mapping table 50A, 50B or 50C as the name of the initiator that is permitted to connect to its own storage apparatus (SP50).

If the result of this judgment is negative, that means no logical volume VOL in the first to third storage apparatuses 3A to 3C has been assigned for the initiator that has transmitted the iSCSI login request message, i.e., the initiator is not permitted to connect to its own storage apparatus. The processor 30A then terminates this IP packet reception processing. Accordingly, the first, second or third storage apparatus 3A, 3B or 3C does not transmit an iSCSI response message to the initiator (host computer 2A, 2B, 2C . . . or second storage apparatus 3B).

On the other hand, if the result of the above judgment is negative, that means a logical volume VOL in one of the first to third storage apparatuses 3A to 3C has been assigned to the initiator that has transmitted the iSCSI login request message, i.e., the initiator is permitted to connect to its own storage apparatus.

Then the processor 30A creates an iSCSI login response message by setting the IP address of its own storage apparatus (i.e., the port number of the port 6A₁, 6A₂, 6B₁ or 6C (FIG. 1) that has been permitted to be accessed) as the “Target Address” and setting the target name of the target function that has been permitted to be accessed as “Target Name” (SP51), and transmits the iSCSI login response message to the transmitter of the received IP packet (SP52). The processor 30A then terminates the IP packet reception processing.

FIG. 5 shows the flow of operations when the host computer 2A logs in to the second storage apparatus 3B and the second storage apparatus 3B logs in to the third storage apparatus 3C, as a result of the above-described iSCSI login processing and IP packet reception processing.

When the host computer 2A logs in to the first or second storage apparatus 3A or 3B by iSCSI, the host computer 2A outputs to the first network 4 an iSCSI login request message with its destination set to the anycast address that can be received by the first and second storage apparatuses 3A and 3B (SP10). This iSCSI login request message has the same content as a conventional login request message using the “Send Targets,” but different from a conventional one in that the IP address is set to anycast.

The first and second storage apparatuses 3A and 3B perform the IP packet reception processing described above with reference to FIG. 9, and as a result, the first storage apparatus 3A transmits an iSCSI login response message to the host computer 2A (SP11). Upon reception of this iSCSI login response message, the host computer 2A starts the login processing for logging in to the first storage apparatus 3A. Since the second storage apparatus 3B did not transmit an iSCSI login response message, the host computer 2A does not perform the login processing for logging in to the second storage apparatus 3B.

Similarly, when the second storage apparatus 3B logs in to the third storage apparatus 3C, the second storage apparatus 3B transmits an iSCSI login request message to the third storage apparatus 3C (SP12), and the third storage apparatus 3C transmits an iSCSI login response message to the second storage apparatus 3B in response to this iSCSI login request message (SP13). Upon receiving this iSCSI login response message, the second storage apparatus 3B starts the login processing for logging in to the third storage apparatus 3C.

Comparing the iSCSI login method shown in FIG. 5 with the conventional iSCSI login processing using a SLP described above with reference to FIG. 4, it is understood that the SLP is not required and the iSCSI login processing can be simplified in the iSCSI login method of this embodiment.

(1-2-3) Creation and Management Methods for Tables

Next, creation and management methods for the LUN mapping tables 50A to 50C (FIG. 6) and the storage group management table 55A (FIG. 7) will be described.

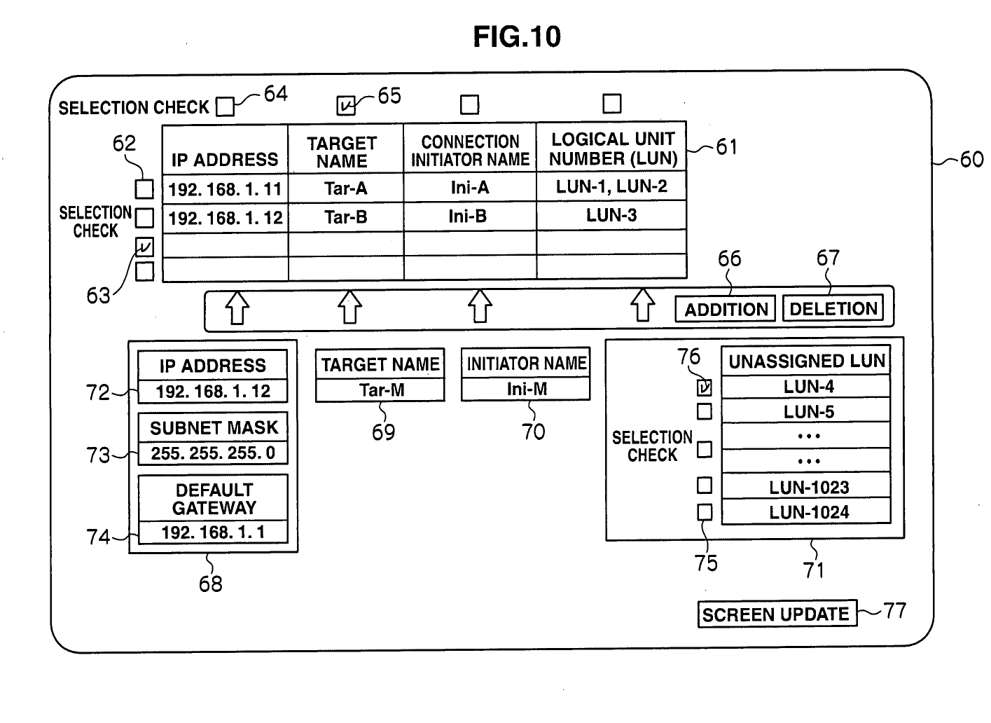

In the storage system 1 in this embodiment, the management terminals 25 of the first to third storage apparatuses 3A to 3C are adapted to display a LUN mapping table creation/management screen 60 shown in FIG. 10 as a means for creating and managing the LUN mapping tables 50A to 50C.

In the LUN mapping table creation/management screen 60, the content of the LUN mapping table 50A, 50B or 50C stored in the memory 23 in the relevant first, second or third storage apparatus 3A, 3B or 3C (FIG. 2) is visibly displayed in a LUN mapping table display section 61 formed in the upper side in the screen. Displayed around the LUN mapping table display section 61 are first checkboxes 62 corresponding to entries in the relevant LUN mapping table 50A, 50B or 50C and second checkboxes 64 corresponding to items (“IP address,” “target name,” “connection initiator” and “logical unit number”) in the relevant LUN mapping table 50A, 50B or 50C.

In this LUN mapping table creation/management screen 60, by clicking the first checkbox 62 corresponding to a desired entry to display a checkmark 63 in this first checkbox 62 and by clicking the second checkbox 64 corresponding to a desired item in the relevant entry to display a checkmark 65 in this second checkbox 64, the relevant entry and item can be selected as targets to be edited.

Displayed below the LUN mapping table display section 61 are an addition button 66 and a deletion button 67 and displayed further below are an IP address input box 68, a target name input box 69, an initiator name input box 70 and an unassigned LUN box 71.

The IP address input box 68 contains an IP address field 72, a subnet mask field 73 and a default gateway field 74, and a new IP address, a subnet mask or a default gateway address, which the user seeks to add to the relevant LUN mapping table 50A, 50B or 50C, can be input into the relevant IP address field 72, the subnet mask field 73 and the default gateway field 74. Similarly, a new target name and a new connection initiator name that the user tries to add to the relevant LUN mapping table 50A, 50B or 50C can be input respectively in the target name input box 69 and the initiator name input box 70.

An unassigned LUN box 72 displays a list of LUNs of unassigned logical volumes VOL that have not been assigned to any initiator, and third checkboxes 75 corresponding to these LUNs. In the unassigned LUN box 71, by clicking a third checkbox 75 corresponding to a desired LUN to display a checkmark 76 in the clicked third checkbox 75, the desired LUN can be selected as the LUN of a new logical volume VOL to be added to the LUN mapping tables 50A to 50C.

In the LUN mapping table creation/management screen 60, by selecting a desired item in a desired entry as described above and then clicking the additional button 66, the IP address, the target name or the initiator name displayed in the IP address input box 68, the target name input box 69 or the initiator name input box 70 or the LUN selected in the unassigned LUN box 71, which corresponds to the selected item, can be added to the relevant item in the relevant entry in the relevant LUN mapping table 50A, 50B or 50C. Likewise, by selecting a desired item in a desired entry as described above and then clicking the deletion button 67, the content of the relevant item in the relevant entry can be deleted from the relevant LUN mapping table 50A, 50B or 50C.

When the LUN mapping table 50A, 50B or 50C is edited as described above in the LUN mapping table creation/management screen 60 and then an update command for the LUN mapping table 50A, 50B or 50C is input, the management terminal 25 accesses the relevant memory 23 via the management interface controller 24 (FIG. 2), and updates the relevant LUN mapping table 50A, 50B or 50C stored in the relevant memory 23 so that its content corresponds to the content edited in the LUN mapping table creation/management screen 60.

A screen update button 77 is provided on the lower right part of the LUN mapping table creation/management window 60. When the screen update button 77 is clicked, the management terminal 25 accesses the relevant memory 23 via the management interface controller 24, reads the relevant LUN mapping table 50A, 50B or 50C stored in the accessed memory 23, and displays the read LUN mapping table 50A, 50B or 50C in the LUN mapping table display section 61 in the LUN mapping table creation/management screen 60. Accordingly, the content of the up-to-date LUN mapping table 50A, 50B or 50C can be displayed in the LUN mapping table display section 61.

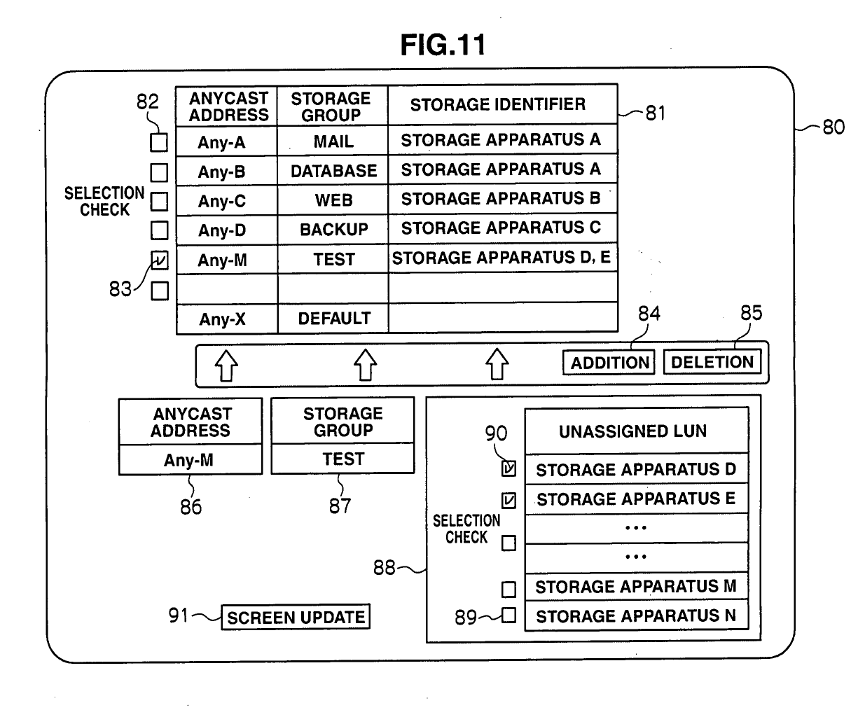

A storage group management table creation/management screen 80 as shown in FIG. 11 can also be displayed on the management terminals 25 in the first to third storage apparatuses 3A to 3C, as a means for creating and managing the storage group management table 55A (FIG. 7A).

In the storage group management table creation and management screen 80, the content of the storage group management table 55A stored in the memory 23 (FIG. 2) in the relevant first, second or third storage apparatus 3A, 3B or 3C is visibly displayed in a storage group management table display section 81 provided on the upper part of the screen. Displayed on the left side of this storage group management table display section 81 are first checkboxes 82 corresponding to entries (respective storage groups) excluding the “default” in the storage group management table 55A.

With the above arrangement, by clicking the first checkbox 82 corresponding to a desired entry (storage group) to display a checkmark 83 in the clicked first checkbox 82 in the storage group management table creation/management screen 80, the desired entry can be selected as a target to be edited.

Displayed below the storage group management table display section 81 are an addition button 84 and a deletion button 85, and displayed further below are an anycast address input box 86, a storage group input box 87 and an unassigned storage box 88.

In the storage group management table creation/management screen 80, a user can input the anycast address to be assigned to an existing or a newly created storage group and the name to be assigned to this storage group respectively in the anycast address input box 86 and the storage group input box 87.

The unassigned storage box 88 displays a list of identifiers of unassigned storage apparatuses that have not been assigned to (do not belong to) any storage group and also displays second checkboxes 89 corresponding to the identifiers of the unassigned storage apparatuses. In the unassigned storage boxes 88, by clicking a second checkbox 89 corresponding to a desired storage apparatus to display a checkmark 90 in the clicked second checkbox 89, that storage apparatus can be selected as a target to be newly assigned to one of the storage groups.

With the arrangement, in the storage group management table creation/management screen 80, by clicking the addition button 84 after selecting a desired entry (storage group) as described above, the anycast address and the storage group name displayed respectively in the anycast address input box 86 and storage group input box 87 at that time and the identifier of the storage apparatus selected in the unassigned storage box 88 can be entered as the any cast address, the storage group and the storage identifier for the selected entry in the storage group management table 55A. Also, in the storage group management table creation/management screen 80, by clicking the deletion button 85 after selecting a desired item in a desired entry as described above, the desired entry can be deleted from the storage group management table 55A.

If the storage group management table 55A is edited as described above in the storage group management table creation/management screen 80 and then an update command for this storage group management table 55A is input, the management apparatus 25 accesses the relevant memory 23 via the relevant management interface controller 24 and updates the storage group management table 55A stored in the relevant memory 23 in accordance with the content edited in the storage group management table creation/management screen 80.

A screen update button 91 is provided on the lower right side in the storage group management table creation/management screen 80. When the screen update button 91 is clicked, the management terminal 25 accesses the relevant memory 23 via the relevant management interface controller 24, reads the storage group management table 55A stored in the relevant memory 23 and displays this storage group management table 55A in the storage group management table display section 81 in the storage group management table creation/management window 80. Accordingly, the content of the up-to-date storage group management table 55A is displayed in the storage group management table display section 81.

(1-3) Effect of First Embodiment

In the storage system 1 in this embodiment, when an initiator logs in to a target, the initiator issues an iSCSI login request message with its destination set to a desired anycast address, and only a target that has permitted the connection of this initiator, from among the targets that received the iSCSI login request message, transmits a login response message. With the above arrangement, an extra protocol or server such as an SLP or an iSNS server is not required, which realizes a storage system capable of simplifying the login processing for the initiator to login to the target, and also capable of simplifying the configuration of the entire system.

### (2) Second Embodiment

In FIGS. 1 and 2, the reference numeral 100 denotes the entire storage system according to a second embodiment. This storage system 100 is different from the storage system 1 in the first embodiment in the content of the processing when the judgment result is negative in step SP50 in the iSCSI login processing described above with reference to FIG. 9.

In the storage system 100 according to this embodiment, when an iSCSI login request is received from an initiator whose initiator name has not been entered in the LUN mapping tables 50A to 50C, the system 100 stores the name of the relevant initiator (initiator name), instead of terminating the iSCSI login processing without doing anything, so that the initiator name can be used later for creating and managing the LUN mapping tables 50A to 50C.

Specifically, when receiving an IP packet from an initiator, the processor 30A (FIG. 2) in the interface controller 21A that functions as the target in the relevant storage apparatus 3A, 3B or 3C performs the same processing as the IP packet reception processing described above with reference to FIG. 9, except when the judgment result is negative in step SP50.

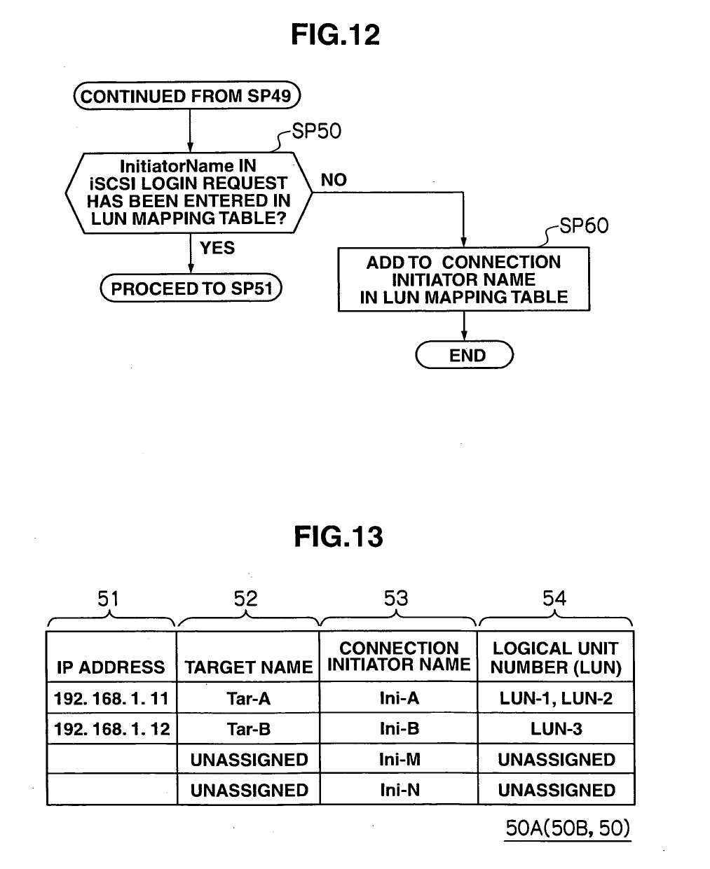

If the judgment result is negative in step SP50 in the above IP packet reception processing, as shown in FIGS. 12 and 13, the processor 30A adds a new entry to the relevant LUN mapping table 50A, 50B or 50C, and stores in the “Connection Initiator Name” field 53 in the relevant entry the initiator name of the transmitter of the received iSCSI login request, the initiator name having been set as the “Initiator Name” in that iSCSI login request. In this step, the processor 30A stores information indicating that the relevant target name and LUN are “unassigned” in the “Target Name” field 52 and the “Logical Unit Number (LUN)” field 54 in the added entry (SP60). Then the processor 30A terminates the IP packet reception processing according to this embodiment.

The assignment of target or logical volume VOL for the initiator that has been newly entered in the relevant LUN mapping table 50A, 50B or 50C is performed using the LUN mapping table creation/management screen 60 described above with reference to FIG. 10.

During this assignment, since the relevant LUN mapping table 50A, 50B or 50C having the content shown in FIG. 13 is displayed as it is in the LUN mapping table display section 61 in the LUN mapping table creation/management screen 60, all the user has to do is to assign the target and logical volume VOL for the entry (initiator) for which no target and logical volume VOL have been assigned.

As described above, when receiving an iSCSI login request from the initiator whose initiator name has not been entered in the LUN mapping tables 50A to 50C, the storage system 100 according to this embodiment enters the name of that initiator (initiator name) in the LUN mapping tables 50A to 50C. This arrangement can simplify the operation when, for example, a new host computer is added in the storage system 100 and information about the new host computer is additionally entered in the LUN mapping tables 50A to 50C in the first to third storage apparatuses 3A to 3C.

### (3) Another Embodiment

Although the LUN mapping tables 50A to 50C each include the “IP Address” field 51, the “Target Name” field 52, the “Connection Initiator Name” field 53 and the “Logical Unit Number (LUN)” field 54 in the above first and second embodiments, this invention is not limited to this arrangement. For example, the LUN mapping tables 50A to 50C may each include a field for storing authentication information for a target or an initiator that is used in the iSCSI login, and the information stored in that field may be displayed in the LUN mapping table creation/management screen 60.

Although the IP address is used as the anycast address in the above first and second embodiment, this invention is not limited to this arrangement. Multicast address unique to a vender having an MAC address may be used within the range connected by a layer 2 switch, or a WWN (World Wide Name) unique to a vender may be used within the range connected by a fibre channel switch.

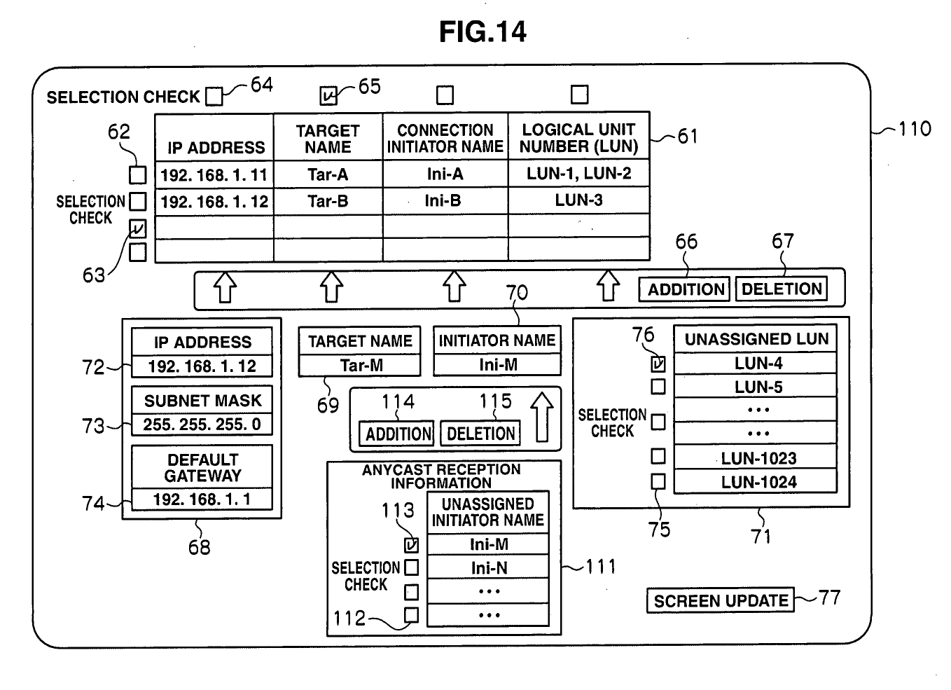

Although an entry (initiator) for which no target and logical volume VOL entered in the LUN mapping tables 50A to 50C have been assigned is also displayed in the LUN mapping table display section 61 in the LUN mapping table creation/management screen 60, this invention is not limited to that arrangement. Alternatively, the arrangement shown in FIG. 14, in which like components are assigned like numerals from FIG. 10, may be employed, where information for an entry for which no target and logical volume VOL have been assigned is not displayed in the LUN mapping table display section 61 in the LUN mapping table creation/management screen 110, the initiator names of such entries are displayed as a list in the LUN mapping table creation/management screen 110, and the initiator name to be entered in the LUN mapping tables 50A to 50C can be selected from the initiator names displayed in the list.

In the example shown in FIG. 14, the initiator names of entries (initiators) for which no target and logical volume VOL entered in the LUN mapping tables 50A to 50C have been assigned are displayed in a list in an anycast reception information display section 111, and by clicking a desired one of the checkboxes 112 corresponding to the initiator names to display a checkmark 113 in the clicked checkbox 112, a desired initiator can be selected.

Displayed above the anycast reception information display section 111 are an unassigned initiator addition button 114 and an unassigned initiator deletion button 115, and by selecting one initiator in the anycast reception information display section 111 and then clicking the unassigned initiator addition button 114, the initiator name of the selected initiator can be displayed in the initiator name input box 70, while by clicking the unassigned initiator deletion button 115, the initiator name displayed in the initiator name input box 70 at that time can be deleted.

By arranging the LUN mapping table creation/management screen 110 as described above also in the second embodiment, the operation required for entering new initiators to the LUN mapping tables 50A to 50C can be simplified.

The host computers 2A, 2B, 2C . . . and the interface controller 21B connected to the second network 5 in the second storage apparatus 3B, which each serve as an initiator-side login processor for storing an anycast address for each storage group, and issue, when logging in to a target belonging to a desired storage group, an iSCSI login request message with its destination set to the anycast address assigned to the desired storage group, are each arranged as shown in FIG. 2 in the above first and second embodiments, but this invention is not limited to this arrangement. A wide variety of other arrangements may be employed for the host computers 2A, 2B, 2C . . . and the interface controller 21B in the second storage apparatus 3B.

The interface controllers 21A in the storage apparatuses 3A to 3C that serve as target-side login processors, which each store at least the anycast address assigned to the storage group to which the relevant storage apparatus itself belongs and information for identifying the initiator that has been permitted to connected to itself (LUN mapping tables 50A to 50C), and transmit, when receiving an iSCSI login request message with its destination set to the anycast address assigned to the storage group to which the relevant storage apparatus itself belongs and only when the initiator that transmitted this iSCSI login request message is permitted to connect to itself, an iSCSI login response message to the relevant initiator, are arranged as shown in FIG. 2 in the above first and second embodiments, but this invention is not limited to that arrangement. A wide variety of other arrangements may be employed for the interface controllers 21A.

Although the management terminal 25, which serves as a display unit for displaying the storage management table 55A or 55B (first table) and the LUN mapping table 50A or 50B (second table) in such a manner that those tables can be edited as a result of external manipulation, employs a laptop personal computer in the above first and second embodiments, this invention is not limited to that arrangement, and a wide variety of other arrangements may be employed.

This invention can be widely applied in storage systems having various configurations.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. An information processing system that comprises an initiator and a target(s) and requires login when the initiator accesses the target(s), wherein:
one or a plurality of targets is classified in one or a plurality of groups, each group being assigned a unique address;
the initiator includes an initiator-side login processor that stores the address assigned to each group of the target(s) and, when logging in to a target belonging to a desired group, issues a login request with its destination set to the address assigned to the desired group; and
the target(s) includes a target-side login processor that stores at least the address assigned to a group to which the relevant target itself belongs and information for identifying the initiator that is permitted to connect to the relevant target itself, and transmits, when receiving the login request whose destination is the address assigned to the group to which the relevant target itself belongs and only when a transmitter of the login request is an initiator that is permitted to connect to the relevant target itself, a login response to the relevant initiator.

2. The information processing system according to claim 1, wherein:
the initiator is a host computer serving as a host system or a first storage apparatus that provides a storage area to the host computer; and
the target is a second storage apparatus that provides a storage area to the host computer or to the first storage apparatus.

3. The information processing system according to claim 1, wherein the target-side login processor transmits, when the login request whose destination is the address assigned to the group to which the relevant target itself belongs and only when the transmitter of this login request is an initiator for which a storage area provided by its own target itself has been assigned, a login response to the relevant initiator.

4. The information processing system according to claim 1, wherein the targets are classified in the plurality of groups according to applications.

5. The information processing system according to claim 1, wherein the initiator-side login processor logs in to, when receiving login responses from the plurality of targets, all of or a part of the targets that have transmitted the login responses.

6. The information processing system according to claim 1, wherein:
the initiator-side login processing and/or the target-side login processing store(s) a first table for managing the address of each group of the target(s); and
the initiator and/or the target include(s) a display unit that displays the first table in such a manner that the first table can be edited in accordance with external manipulation.

7. The information processing system according to claim 1, wherein the target-side login processor stores, when the login request whose destination is the address assigned to the group to which the relevant target itself belongs is received and the transmitter of this login request is an initiator that is not permitted to connect to the relevant target itself, information for identifying the initiator contained in the login request.

8. The information processing system according to claim 8, wherein:
the target-side login processor stores a second table for managing a storage area assigned to the initiator; and
the target includes a display unit that displays the second table in such a manner that the second table can be edited in accordance with external manipulation.

9. A login method used for an information processing system that includes an initiator and a target(s) and requires login when the initiator accesses the target(s), the method comprising the steps of:
a first step in which one or a plurality of targets is classified into one or a plurality of groups, a unique address is assigned to each group, the initiator stores the address assigned to each target group, and the target(s) stores at least the address assigned to a group to which the relevant target itself belongs and information for identifying an initiator that is permitted to connect to the relevant target itself;
a second step in which, the initiator issues, when logging in to a target belonging to a desired group, a login request whose destination is the address assigned to the desired group; and
a third step in which the target(s) transmits, when the target(s) receives the login request whose destination is the address assigned to the group to which the relevant target itself belongs and only when a transmitter of the login request is an initiator that is permitted to connect to the relevant target itself, a login response to the relevant initiator.

10. The login method according to claim 9, wherein:
the initiator is a host computer serving as a host system or a first storage apparatus that provides a storage area to the host computer; and
the target is a second storage apparatus that provides a storage area to the host computer or the first storage apparatus.

11. The login method according to claim 9, wherein, in the third step, when the login request whose destination is the address assigned to the group to which the relevant target itself belongs and only when the transmitter of this login request is an initiator for which a storage area provided by its own storage apparatus has been assigned, the target transmits a login response to the relevant initiator.

12. The login method according to claim 9, wherein, in the first step, the targets are classified in the plurality of groups according to application.

13. The login method according to claim 9, wherein, in the third step, when the initiator receives login responses from the plurality of targets, the initiator logs in to all of or some of the targets that have transmitted the login responses.

14. The login method according to claim 9, wherein, in the first step:
the initiator and/or the target store(s) a first table for managing the address of each group of the target(s); and
the initiator and/or the target include(s) a display unit that displays the first table in such a manner that the first table can be edited in accordance with external manipulation.

15. The method according to claim 9, wherein, in the third step, the target stores, when the login request whose destination is the address assigned to the group to which the relevant target itself belongs is received and the transmitter of this login request is an initiator that is not permitted to connect to the relevant target itself, information for identifying the initiator contained in the login request.

16. The login method according to claim 15, wherein,
in the first step, the target stores a second table for managing a storage area assigned to the initiator; and
the target includes a display unit that displays the second table in such a manner that the second table can be edited in accordance with external manipulation.
